(19) United States
(12) Patent Application Publication
(10) Pub. No.: US 2024/0339606 A1
(43) Pub. Date: Oct. 10, 2024

(54) POSITIVE ELECTRODE, ENERGY STORAGE DEVICE, AND ENERGY STORAGE APPARATUS

(71) Applicant: GS Yuasa International Ltd., Kyoto-shi, Kyoto (JP)

(72) Inventor: Morito TANABE, Kyoto (JP)

(21) Appl. No.: 18/576,044

(22) PCT Filed: Jun. 6, 2022
(86) PCT No.: PCT/JP2022/022779

§ 371 Date: Jan. 2, 2024

(30) Foreign Application Priority Data
Jul. 6, 2021 (JP) 2021-112393

(51) Int. Cl. H01M 4/525; H01M 4/02; H01M 4/131; H01M 4/62

(52) U.S. Cl. CPC H01M 4/525; H01M 4/131; H01M 4/623; H01M 2004/021; H01M 2004/028

(57) ABSTRACT

A positive electrode for an energy storage device according to an aspect of the present invention includes a positive active material layer, the positive active material layer contains positive active material particles and a binder, the positive active material particles contain a nickel-containing lithium transition metal composite oxide that has an α-NaFeO₂-type crystal structure, the positive active material particles are at least one of: primary particles that are not substantially aggregated; and secondary particles that have primary particles aggregated, with the ratio of the median size to the average primary particle size being 5 or less, the product of the median size and BET specific surface area of the positive active material particles is 1.3 [μm m²/g] or more and 4.0 [μm m²/g] or less, and the binder has a weight average molecular weight of 500,000 or more.

### TECHNICAL FIELD

The present invention relates to a positive electrode, an energy storage device, and an energy storage apparatus.

### BACKGROUND ART

Nonaqueous electrolyte secondary batteries typified by lithium ion secondary batteries are often used for electronic devices such as personal computers and communication terminals, motor vehicles, and the like since, because the batteries are high in energy density. The nonaqueous electrolyte secondary batteries generally include a pair of electrodes electrically separated from each other by a separator, and a nonaqueous electrolyte interposed between the electrodes, and are configured to allow ions to be transferred between the two electrodes for charge-discharge. Also, capacitors such as lithium ion capacitors and electric double-layer capacitors, energy storage devices with electrolytes other than nonaqueous electrolyte used, and the like are also widely used as energy storage devices other than nonaqueous electrolyte secondary batteries.

Positive active materials composed of secondary particles of primary particles aggregated and positive active materials composed of single particles of primary particles dispersed without being aggregated are known as positive active materials for use in the energy storage devices. As a single-particle positive active material, Patent Document 1 describes an invention of a positive active material for a nonaqueous secondary battery, which is a powdered lithium composite oxide of monodispersed primary particles containing, as main components, one element selected from the group consisting of cobalt, nickel, and manganese, and lithium, with the average particle size and specific surface area of the primary particles being controlled respectively in specific ranges.

### PRIOR ART DOCUMENT

### Patent Document

Patent Document 1: JP-A-2004-355824

### SUMMARY OF THE INVENTION

### Problems to be Solved by the Invention

Energy storage devices obtained by using such a positive electrode including a positive active material containing a nickel-containing transition metal composite oxide have the problem of inadequate capacity retention ratios after charge-discharge cycles.

An object of the present invention is to provide a positive electrode capable of suppressing a decrease in the capacity retention ratio of the energy storage device after a charge-discharge cycle. In addition, another object of the present invention is to provide an energy storage device and an energy storage apparatus capable of suppressing a decrease in capacity retention ratio after a charge-discharge cycle.

### Means for Solving the Problems

A positive electrode for an energy storage device according to an aspect of the present invention includes a positive active material layer, the positive active material layer contains positive active material particles and a binder, the positive active material particles contain a nickel-containing lithium transition metal composite oxide that has an α-NaFeO₂-type crystal structure, the positive active material particles are at least one of: primary particles that are not substantially aggregated; and secondary particles that have primary particles aggregated, with the ratio of the median size to the average primary particle size being 5 or less, the product of the median size and BET specific surface area of the positive active material particles is 1.3 [μm m²/g] or more and 4.0 [μm m²/g] or less, and the binder has a weight average molecular weight of 500,000 or more.

An energy storage device according to another aspect of the present invention includes the positive electrode for the energy storage device.

An energy storage apparatus according to another aspect of the present invention includes two or more energy storage devices and one or more energy storage devices according to the above-mentioned other aspect of the present invention.

### Advantages of the Invention

The positive electrode according to an aspect of the present invention is capable of suppressing a decrease in the capacity retention ratio of the energy storage device after a charge-discharge cycle. In addition, the energy storage device according to an aspect of the present invention is capable of suppressing a decrease in capacity retention ratio after a charge-discharge cycle, and the energy storage apparatus according to another aspect of the present invention is capable of suppressing a decrease in capacity retention ratio after a charge-discharge cycle.

### BRIEF DESCRIPTION OF THE DRAWINGS

FIG. 1 is a see-through perspective view illustrating an embodiment of an energy storage device.

FIG. 2 is a schematic diagram illustrating an embodiment of an energy storage apparatus including a plurality of energy storage devices assembled.

### MODE FOR CARRYING OUT THE INVENTION

An embodiment of the present invention provides the following respective aspects.

Item 1.

A positive electrode for an energy storage device, including a positive active material layer,
where the positive active material layer contains positive active material particles and a binder,
the positive active material particles contain a nickel-containing lithium transition metal composite oxide that has an α-NaFeO₂-type crystal structure,
the positive active material particles are at least one of: primary particles that are not substantially aggregated; and secondary particles that have primary particles aggregated, with the ratio of the median size to the average primary particle size being 5 or less,
the product of the median size and BET specific surface area of the positive active material particles is 1.3 [μm m²/g] or more and 4.0 [μm m²/g] or less, and
the binder has a weight average molecular weight of 500,000 or more.

Item 2.

The positive electrode according to item 1, where the lithium transition metal composite oxide includes nickel, cobalt, and at least one of manganese and aluminum.

Item 3.

The positive electrode according to item 1 or 2, where the binder contains a fluorine-containing resin.

Item 4.

The positive electrode according to item 1, 2, or 3, where the content of the binder in the positive active material layer is 0.1% by mass or more and 2.0% by mass or less.

Item 5.

An energy storage device including the positive electrode according to any one of items 1 to 4.

Item 6.

An energy storage apparatus including two or more energy storage devices, and one or more energy storage devices according to item 5.

First, outlines of a positive electrode and an energy storage device disclosed in the present specification will be described.

A positive electrode for an energy storage device according to an aspect of the present invention includes a positive active material layer, the positive active material layer contains positive active material particles and a binder, the positive active material particles contain a nickel-containing lithium transition metal composite oxide that has an α-NaFeO₂-type crystal structure, the positive active material particles are at least one of: primary particles that are not substantially aggregated; and secondary particles that have primary particles aggregated, with the ratio of the median size to the average primary particle size being 5 or less, the product of the median size and BET specific surface area of the positive active material particles is 1.3 [μm m²/g] or more and 4.0 [μm m²/g] or less, and the binder has a weight average molecular weight of 500,000 or more.

In the positive electrode, the positive active material layer contains positive active material particles and a binder, the binder has a weight average molecular weight of 500,000 or more, the positive active material particles contain a nickel-containing lithium transition metal composite oxide that has an α-NaFeO₂-type crystal structure, the positive active material particles are at least one of: primary particles that are not substantially aggregated; and secondary particles that have primary particles aggregated, with the ratio of the median size to the average primary particle size being 5 or less, and the product of the median size and BET specific surface area of the positive active material particles is 1.3 [μm m²/g] or more and 4.0 [μm m²/g] or less. The positive electrode is, even when the positive active material layer contains the positive active material particles, capable of suppressing a decrease in the capacity retention ratio of the energy storage device after a charge-discharge cycle, in combination with the binder that has a weight average molecular weight of 500,000 or more. Although the reason therefor is not clear, the following reason is presumed. The positive active material particles that contain a nickel-containing lithium transition metal composite oxide that has an α-NaFeO₂-type crystal structure, and are at least one of: primary particles that are not substantially aggregated; and secondary particles that have primary particles aggregated, with the ratio of the median size to the average primary particle size being 5 or less, with the product of the median size and the BET specific surface area being 1.3 [μm m²/g] or more and 4.0 [μm m²/g] or less, have fewer irregularities at the particle surfaces, and thus, can suppress deterioration due to a reaction with an electrolyte solution. The positive electrode with such a positive active material used, however, has fewer irregularities at the particle surfaces of the positive active material, and thus a reduced number of contact points with the binder, and thus, when a low-molecular-weight binder is used, the adhesion between the positive active material particles fails to be maintained, and the capacity retention ratio of the energy storage device with such a positive electrode used after a charge-discharge cycle is more likely to be decreased. In contrast, the binder that has a weight average molecular weight of 500,000 or more, contained in the positive active material layer of the positive electrode, can increase the adhesion between the positive active material particles even for the positive active material particles with fewer irregularities at the particle surfaces. Accordingly, the positive electrode is presumed to be capable of suppressing a decrease in the capacity retention ratio of the energy storage device after a charge-discharge cycle. In addition, when the product of the median size and BET specific surface area of the positive active material particles falls within the range mentioned above, thereby making a reaction with a nonaqueous electrolyte or the like less likely to be caused, and thus allowing the effect of the invention of the present application to be further produced. Additionally, in the positive electrode, at least one of: primary particles that are not substantially aggregated; and secondary particles that have primary particles aggregated, with the ratio of the median size (average secondary particle size) to the average primary particle size being 5 or less are used as the positive active material particles (hereinafter, “the primary particles that are not substantially aggregated; and secondary particles that have primary particles aggregated, with the ratio of the median size to the average primary particle size being 5 or less” are also collectively referred to as a “single-particle-based particles”). Such single-particle-based particles are less likely to cause cracks or the like due to repeated charge-discharge, and thus capable of increasing the capacity retention ratio of the nonaqueous electrolyte energy storage device after a charge-discharge cycle. Furthermore, the positive active material particles contain a nickel-containing lithium transition metal composite oxide, thereby allowing the energy density of the energy storage device to be increased.

“The primary particles that are not substantially aggregated” refer to a plurality of primary particles that are present independently without being aggregated, or a primary particle and another primary particle that are not generally directly bound to each other, when the primary particles are observed with a scanning electron microscope (SEM). The primary particles are particles in which no grain boundary is observed in appearance in the observation with the SEM.

The “average primary particle size” of the positive active material particles is the average value of respective particle sizes of arbitrary fifty primary particles constituting the positive active material particles observed with the SEM. The particle sizes of the primary particles are determined as follows. The shortest diameter passing through the center of the minimum circumscribed circle of the primary particle is defined as a minor axis, and the diameter passing through the center and orthogonal to the minor axis is defined as a major axis. The average value of the major axis and the minor axis is defined as the particle size of the primary particle. When there are two or more shortest diameters, the shortest diameter with the longest orthogonal diameter is defined as the minor axis.

The “median size” of the positive active material particles means a value (D50) at which a volume-based cumulative distribution calculated in accordance with JIS-Z-8819-2 (2001) is 50%, based on a particle size distribution measured by a laser diffraction/scattering method for a diluted solution obtained by diluting the positive active material particles with a solvent in accordance with JIS-Z-8815 (2013). Further, it has been confirmed that the median size based on the measurement mentioned above is almost equal to the average secondary particle size that is the average value of particle sizes of respective secondary particles of the positive active material particles, measured with hundred particles extracted from the SEM image of the positive active material particles, excluding extremely large particles and extremely small particles. The particle sizes of respective secondary particles of the positive active material particles, based on the measurement from the SEM image, are determined as follows. The SEM image of the positive active material particles is acquired according to the case of determining the “average primary particle size” mentioned above. The shortest diameter passing through the center of the minimum circumscribed circle of each secondary particle of the positive active material particles is defined as a minor axis, and the diameter passing through the center and orthogonal to the minor axis is defined as a major axis. The average value of the major axis and the minor axis is defined as the particle size of each secondary particle of the positive active material particles. When there are two or more shortest diameters, the shortest diameter with the longest orthogonal diameter is defined as the minor axis. The positive active material particles for measuring the average primary particle size and the median size are positive active material particles in a state fully discharged by a method described later.

In this regard, when the positive active material particles are assumed to be spheres without irregularities at the particle surfaces, the relationship between the median size and BET specific surface area of the positive active material particles is expressed by the following formula:

$$B E T specific surface area ( {m}^{2} / g ) = 4 Π \times {( median size ( µm ) / 2 )}^{2} / \{ ( 4 Π / 3 ) \times {( median size ( µm ) / 2 )}^{3} \times true density ( g / {cm}^{3} ) \}$$

The following equation is derived by modification of the equation mentioned above.

$$B E T specific surface area ( {m}^{2} / g ) \times medium size ( µm ) = 6 / true density ( g / {cm}^{3} )$$

In this regard, the true density of LiNiO₂ that is a nickel-containing lithium transition metal composite oxide is about 4.7 (g/cm³), and thus, the product of the BET specific surface area and the median size is about 1.3 [μm m²/g]. While the product of the BET specific surface area and the median size is larger than 1.3 because the actual positive active material particles, at the surfaces thereof, have fine irregularities and cracks, the effect of suppressing a decrease in the capacity retention ratio of the energy storage device after a charge-discharge cycle is produced when the positive active material particles with the product of 4.0 [μm m²/g] or less are combined with a binder that has a weight average molecular weight of 500,000 or more.

The “median size” of the positive active material particles specifically has a value measured by the following method. A laser diffraction type particle size distribution measuring apparatus (“SALD-2200” from Shimadzu Corporation) is used as a measuring apparatus, and Wing SALD-2200 is used as measurement control software. With a scattering measurement mode employed, a wet cell in which a dispersion liquid with a measurement sample dispersed in a dispersion solvent is circulated is irradiated with a laser beam to obtain a scattered light distribution from the measurement sample. Then, the scattered light distribution is approximated with a log-normal distribution, and a particle size corresponding to an accumulation degree of 50% on a volume basis is defined as the median size (D50).

The “BET specific surface area” mentioned above is determined by immersing in liquid nitrogen, and measuring the pressure and the amount of adsorption at the time, based on the fact that nitrogen molecules are physically adsorbed on the particle surfaces by supplying a nitrogen gas. As a specific measurement method, the amount of nitrogen adsorption (m²) with respect to the sample is determined by a one-point method. The value obtained by dividing the obtained amount of nitrogen adsorption by a mass (g) of the sample is defined as the BET specific surface area (m²/g).

The “weight average molecular weight” mentioned above means an average molecular weight measured with the use of gel permeation chromatography (GPC) in accordance with JIS-K-7252-1 (2008) “Plastics—Determination of Average Molecular Weight and Molecular Weight Distribution of Polymer by Size Exclusion Chromatography—Part 1: General Rules”.

The lithium transition metal composite oxide mentioned above preferably contains nickel, cobalt, and at least one of manganese element and aluminum. The use of such a lithium transition metal composite oxide allows the energy density the energy storage device to be increased.

The binder mentioned above preferably contains a fluorine-containing resin. The binder contains a fluorine-containing resin, thereby further producing the effect of suppressing a decrease in the capacity retention ratio of the energy storage device after a charge-discharge cycle, when the weight average molecular weight is 500,000 or more.

The content of the binder in the positive active material layer is preferably 0.1% by mass or more and 2.0% by mass or less. The content of the binder falls within the range mentioned above, thereby allowing the effect of suppressing a decrease in the capacity retention ratio of the energy storage device after a charge-discharge cycle to be further enhanced, while stably retaining the positive active material.

An energy storage device according to an aspect of the present invention is an energy storage device including the positive electrode. The energy storage device includes the positive electrode, and is thus capable of suppressing a decrease in capacity retention ratio after a charge-discharge cycle.

An energy storage apparatus according to another aspect of the present invention includes two or more energy storage devices, and one or more energy storage devices according to the other aspect of the present invention.

The energy storage apparatus includes the energy storage device capable of suppressing a decrease in capacity retention ratio after a charge-discharge cycle, and is thus capable of suppressing a decrease in capacity retention ratio after a charge-discharge cycle.

The configuration of a positive electrode, the configuration of an energy storage device, the configuration of an electrolyte energy storage apparatus, and a method for manufacturing the energy storage device according to an embodiment of the present invention, and other embodiments will be described in detail. It is to be noted that the names of the respective constituent members (respective constituent elements) for use in the respective embodiments may be different from the names of the respective constituent members (respective elements) for use in the background art.

### Positive Electrode

The positive electrode has a positive substrate and a positive active material layer disposed directly on the positive substrate or over the positive substrate with an intermediate layer interposed therebetween.

The positive substrate has conductivity. Whether the positive substrate has “conductivity” or not is determined with the volume resistivity of 10⁷ Ω·cm measured in accordance with JIS-H-0505 (1975) as a threshold. As the material of the positive substrate, a metal such as aluminum, titanium, tantalum, or stainless steel, or an alloy thereof is used. Among these metals and alloys, aluminum or an aluminum alloy is preferable from the viewpoints of electric potential resistance, high conductivity, and cost. Examples of the positive substrate include a foil, a deposited film, a mesh, and a porous material, and a foil is preferable from the viewpoint of cost. Accordingly, the positive substrate is preferably an aluminum foil or an aluminum alloy foil. Examples of the aluminum or aluminum alloy include A1085, A3003, and A1N30 specified in JIS-H-4000 (2014) or JIS-H-4160 (2006).

The intermediate layer is a layer disposed between the positive substrate and the positive active material layer. The intermediate layer includes a conductive agent such as carbon particles to reduce contact resistance between the positive substrate and the positive active material layer. The configuration of the intermediate layer is not particularly limited, and includes, for example, a binder and a conductive agent.

The positive active material layer contains positive active material particles and a binder that has a weight average molecular weight of 500,000 or more. The positive active material particles contain a nickel-containing lithium transition metal composite oxide that has an α-NaFeO₂-type crystal structure, the positive active material particles are at least one of: primary particles that are not substantially aggregated; and secondary particles that have primary particles aggregated, with the ratio of the median size to the average primary particle size being 5 or less, and the product of the median size and the BET specific surface area is 1.3 [μm m²/g] or more and 4.0 [μm m²/g] or less. The positive active material layer contains optional components such as a conductive agent, a thickener, and a filler, if necessary. The positive electrode is believed to synergistically have the effect of suppressing a decrease in the capacity retention ratio of the energy storage device after a charge-discharge cycle, by combining the positive active material particles with the product of the median size and the BET specific surface area being 1.3 [μm m²/g] or more and 4.0 [μm m²/g] or less with the binder that has a weight average molecular weight of 500,000 or more.

The positive active material particles are single-particle-based particles. The single-particle-based particles are less likely to cause cracks or the like due to repeated charge-discharge, thus capable of increasing the capacity retention ratio of the energy storage device after a charge-discharge cycle. Examples of the single-particle-based particles include primary particles A that are not substantially aggregated (particles that are each a primary particle present alone).

Other examples of the single-particle-based particles include secondary particles B that have primary particles aggregated, with the ratio of the median size (average secondary particle size) to the average primary particle size being 5 or less. The ratio of the median size to the average primary particle size is preferably 4 or less, more preferably 3 or less, still mote preferably 2 or less. The ratio of the ratio of the median size of the secondary particles B to the average primary particle size is equal to or less than the upper limit mentioned above, thereby allowing advantages of the single-particle-based particles to be sufficiently brought, such as the fact that cracks and the like are less likely to be generated. The lower limit of the ratio of the median size of the secondary particles B to the average primary particle size may be 1. From the difference between the method for measuring the primary particle size and the method for measuring the secondary particle size, the lower limit of the ratio of the median size of the secondary particles B to the primary particle size may be less than 1, for example, 0.9.

The positive active material particles that are single-particle—based particles may be obtained by mixing the primary particles A and the secondary particles B. For example, of the arbitrary fifty positive active material particles observed with the SEM, the number of primary particles A is preferably more than twenty five, more preferably thirty or more, and further preferably forty or more. The positive active material particles may be composed substantially of only primary particles A.

The single-particle-based particles can be produced by any known method, and a commercially available product may be used for the single-particle particles. For example, in the process of producing the positive active material particles, increasing the firing temperature or prolonging the firing time causes a plurality of primary particles to grow to increase the particle size, thereby allowing single-particle-based particles to be obtained. Alternatively, the single-particle-based particles can be obtained by crushing the secondary particles.

The positive active material contains a nickel-containing lithium transition metal composite oxide. The positive active material particles contain the nickel-containing lithium transition metal composite oxide, thereby allowing the energy density of the energy storage device to be increased. The nickel-containing lithium transition metal composite oxide can be appropriately selected from known nickel-containing lithium transition metal composite oxides. As the positive active material for a lithium ion secondary battery, a material capable of occluding and releasing lithium ions is typically used, and examples thereof include a lithium transition metal composite oxide that has an α-NaFeO₂-type crystal structure. The positive active material particles preferably contain a nickel-containing lithium transition metal composite oxide that has an α-NaFeO₂-type crystal structure, and the lithium transition metal composite oxide preferably contains the nickel, cobalt, and at least one of manganese and aluminum. The use of such a lithium transition metal composite oxide allows the energy density the energy storage device to be increased.

As the nickel-containing lithium-transition metal composite oxide that has an α-NaFeO₂-type crystal structure, specifically, a compound represented by the following formula (1) is preferable.

Li_{1+α}Me_{1-α}O₂ (1)

In the formula (1), Me is a metal element (excluding Li) containing: Ni; Co; and Mn or Al. The condition of 0≤α<1 is met.

Me in the formula (1) is preferably composed substantially of three elements of Ni, Co, and Mn, four elements of Ni, Co, Mn, and Al, or three elements of Ni, Co, and Al, and more preferably composed of the three elements of Ni, Co, and Mn. Me may, however, contain other metal elements.

From viewpoints such as further increasing the electric capacity, the suitable content (composition ratio) of each constituent element in the compound represented by the formula (1) is as follows. It is to be noted that the molar ratio is equal to the atomic number ratio.

In the formula (1), the lower limit of the molar ratio (Ni/Me) of Ni to Me is preferably 0.1, and more preferably 0.2, 0.3, or 0.4 in some cases. In contrast, the upper limit of the molar ratio (Ni/Me) is preferably 0.9, and more preferably 0.8, 0.7, or 0.6 in some cases.

In the formula (1), the lower limit of the molar ratio (Co/Me) of Co to Me is preferably 0.01, and more preferably 0.1 or 0.2 in some cases. In contrast, the upper limit of the molar ratio (Co/Me) is preferably 0.5, and more preferably 0.4 or 0.3 in some cases.

In the formula (1), the lower limit of the molar ratio (Mn/Me) of Mn to Me may be 0, and is preferably 0.05, and more preferably 0.1 or 0.2 in some cases. In contrast, the upper limit of the molar ratio (Mn/Me) is preferably 0.6, and more preferably 0.4 or 0.3 in some cases.

In the formula (1), the lower limit of the molar ratio (Al/Me) of Al to Me may be 0, and is preferably 0.01, and more preferably 0.02 or 0.03 in some cases. In contrast, the upper limit of the molar ratio (Al/Me) is preferably 0.3, and more preferably 0.2 or 0.1 in some cases.

In the formula (1), the molar ratio (Li/Me) of Li to Me, that is, (1+α)/(1−α), may be 1, and is more than 1.0 (α>0) or 1.1 or more in some cases.

In contrast, the upper limit of the molar ratio (Li/Me) is preferably 1.6, and more preferably 1.4 or 1.2 in some cases.

Further, the composition ratio of the lithium transition metal composite oxide refers to a composition ratio in the case of a completely discharged state provided by the following method. First, the energy storage device is subjected to constant current charge with a current of 0.05 C until the voltage reaches an end-of-charge voltage under normal usage to be brought into a fully charged state. After a 30-minute pause, the energy storage device is subjected to constant current discharge with a current of 0.05 C to the lower limit voltage under normal usage. The energy storage device is disassembled to take out the positive electrode, and a test battery with a metal lithium electrode as a counter electrode is assembled, and subjected to constant current discharge at a current value of 10 mA per 1 g of the positive active material until the positive potential reaches 2.0 V vs. Li/Li⁺, thereby adjusting the positive electrode to the completely discharged state. The battery is disassembled again to take out the positive electrode. The nonaqueous electrolyte attached to the positive electrode taken out is sufficiently washed with a dimethyl carbonate, and dried at room temperature for a whole day and night, and the lithium transition metal composite oxide of the positive active material particles is then collected. The collected lithium transition metal composite oxide is subjected to measurement. The operations from the disassembly of the energy storage device to the collection of the lithium transition metal composite oxide are performed in an argon atmosphere at a dew point of −60° C. or lower. The term “under normal usage” herein refers to a case of using the energy storage device while employing charge-discharge conditions recommended or specified for the energy storage device, and when a charger for the energy storage device is prepared, the term refers to a case of using the energy storage device with the charger applied.

Examples of suitable lithium transition metal composite oxides include LiNi_{1/3}Co_{1/3}Mn_{1/3}O₂, LiNi_{3/5}Co_{1/5}Mn_{1/5}O₂, LiNi_{1/2}Co_{1/5}Mn_{3/10}O₂, LiNi_{1/2}Co_{3/10}Mn_{1/5}O₂, LiNi_{8/10}Co_{1/10}Mn_{1/10}O₂, and LiNi_{0.8}Co_{0.15}Al_{0.05}O₂.

The positive active material particles may contain other positive active material particles besides the nickel-containing lithium transition metal composite oxide that has an α-NaFeO₂-type crystal structure. The other positive active material particles can be appropriately selected from known positive active materials. As the positive active material for a lithium ion secondary battery, a material capable of occluding and releasing lithium ions is typically used. Examples of the positive active material include lithium transition metal composite oxides that have an α-NaFeO₂-type crystal structure, other than the above-mentioned nickel-containing lithium transition metal composite oxides that have an α-NaFeO₂-type crystal structure, polyanion compounds, chalcogenides, and sulfur. Examples of the lithium transition metal composite oxides that have an α-NaFeO₂-type crystal structure include Li[LiₓCo₍₁₋ₓ₎]O₂ (0≤x<0.5). Some of the atoms in these materials may be substituted with atoms composed of other elements. The surfaces of these materials may be coated with other materials.

One of the materials for the positive active material particles may be used alone, or two or more thereof may be used in mixture. In particular, the positive active material particles preferably contain the nickel-containing lithium transition metal composite oxide that has the α-NaFeO₂-type crystal structure in a proportion of 50% by mass or more (preferably 70% by mass to 100% by mass, more preferably 80% by mass to 100% by mass, still more preferably 90% by mass to 100% by mass or more, particularly preferably 95% by mass to 100% by mass or more) of all of the positive active material particles used, and it is more preferable to use positive active material particles composed substantially only of the nickel-containing lithium transition metal composite oxide that has the α-NaFeO₂-type crystal structure.

The positive active material particles with the product of the median size and the BET specific surface area being 1.3 [μm m²/g] or more and 4.0 [μm m²/g] or less can be produced by a known method, and the median size, the BET specific surface area, and the like can be controlled by the production conditions. In addition, for the positive active material particles, a commercially available product may be used. In the process of producing the positive active material, controlling firing conditions makes it possible to obtain the positive active material with a predetermined BET specific surface area. For example, the BET specific surface area can be reduced by increasing the firing temperature or prolonging the firing time. In addition, the use of a crusher, a classifier, or the like makes it possible to obtain the positive active material with a predetermined particle size. Examples of the crushing method include a method of using a mortar, a ball mill, a sand mill, a vibratory ball mill, a planetary ball mill, a jet mill, a counter jet mill, a whirling airflow-type jet mill, a sieve, or the like. At the time of crushing, wet-type crushing in coexistence with water or a nonaqueous solvent such as hexane can also be used.

The lower limit of the product of the median size and BET specific surface area of the positive active material particles is 1.3 [μm m²/g], preferably 1.5 [μm m²/g], more preferably 1.8 [μm m²/g]. In contrast, the upper limit of the product of the median size and BET specific surface area of the positive active material particles is 4.0 [μm m²/g], preferably 3.5 [μm m²/g], more preferably 3.0 [μm m²/g]. When the product of the median size and BET specific surface area of the positive active material particles is equal to or less than the upper limit mentioned above and equal to or more than the lower limit mentioned above, cracks and the like are less likely to be generated, and thus, the effect of suppressing a decrease in the capacity retention ratio of the energy storage device after a charge-discharge cycle can be further produced.

The median size of the positive active material particles is, for example, preferably 1 μm or more and 20 μm or less, more preferably 2 μm or more and 15 μm or less, still more preferably 3 μm or more and 10 μm or less. The median size of the positive active material particles falls within the range mentioned above, thereby facilitating control of the product of the median size and the BET specific surface area to 1.3 [μm m²/g] or more and 4.0 [μm m²/g] or less, and allowing further suppression of a decrease in the capacity retention ratio of the energy storage device after a charge-discharge cycle, and allowing the power performance to be improved.

The BET specific surface area of the positive active material particles is, for example, preferably 0.2 m²/g or more and 1.3 m²/g or less, more preferably 0.25 m²/g or more and 0.7 m²/g or less. The BET specific surface area of the positive active material particles falls within the range mentioned above, thereby inhibiting the reaction between the positive active material particles and the nonaqueous electrolyte, and allowing a decrease in the capacity retention ratio of the energy storage device after a charge-discharge cycle to be further suppressed.

The content of the positive active material particles in the positive material layer is preferably 50% by mass or more and 99% by mass or less, more preferably 70% by mass or more and 98% by mass or less, still more preferably 80% by mass or more and 95% by mass or less. The content of the positive active material particles falls within the range mentioned above, thereby allowing a balance to be achieved between the increased energy density and productivity of the positive active material layer.

The lower limit of the weight average molecular weight of the binder contained in the positive active material layer is 500,000, preferably 600,000, more preferably 700,000. In contrast, the lower limit of the weight average molecular weight of the binder is preferably 1.5 million, more preferably 1.3 million. The weight average molecular weight of the binder is equal to or more than the lower limit mentioned above and equal to or less than the upper limit mentioned above, thereby favorably maintaining the application property of a positive composite paste, and allowing the effect of suppressing a decrease in the capacity retention ratio of the energy storage device after a charge-discharge cycle to be further enhanced.

Examples of the binder include: thermoplastic resins such as fluorine-containing resins (e.g., polytetrafluoroethylene (PTFE), polyvinylidene fluoride (PVDF), a copolymer of vinylidene fluoride and hexafluoropropylene (PVDF-HFP)), polyethylene, polypropylene, polyacryl, and polyimide; elastomers such as an ethylene-propylene-diene rubber (EPDM), sulfonated EPDM, a styrene butadiene rubber (SBR), and a fluororubber; and polysaccharide polymers. Among these examples, the fluorine-containing resins are preferable, which are capable of further enhancing the effect of suppressing a decrease in the capacity retention ratio of the energy storage device after a charge discharge cycle when the weight average molecular weights are adjusted to be 500,000 or more, and the polyvinylidene fluoride and the copolymer of vinylidene fluoride and hexafluoropropylene are more preferable.

Further, in the case of forming the positive active material layer by wet coating, a nonaqueous binder is more preferable as the binder. This is because the use of a nonaqueous solvent as a solvent for the positive composite paste for use in wet coating can facilitate the removal of moisture of the positive electrode, due to the fact that the positive active material containing the nickel-containing transition metal composite oxide has higher hydrophilicity than a carbon material or the like typically for use as a negative active material. In addition, when the positive active material is a lithium transition metal composite oxide, the use of water as a solvent for the positive composite paste causes a lithium hydroxide to be eluted from the positive active material, and thus increases the pH of the positive composite paste, thereby making the positive substrate more likely to be corroded. Corrosion of the positive substrate can be inhibited by using a nonaqueous binder as a binder for the positive active material layer and a nonaqueous solvent as a solvent for the positive composite paste.

The nonaqueous binder is a binder that is dispersed or dissolved in a nonaqueous solvent such as N-methylpyrrolidone (NMP). In particular, a binder that is dissolved in an amount of 1 part by mass or more in 100 parts by mass of NMP at 20° C. is preferable as the nonaqueous binder. As the nonaqueous binder, for example, a polyvinylidene fluoride, a copolymer of vinylidene fluoride and hexafluoropropylene (PVDF-HFP), a copolymer of ethylene and vinyl alcohol, a polyacrylonitrile, a polyphosphazene, a polysiloxane, a polyvinyl acetate, a polymethyl methacrylate (PMMA), a polystyrene, a polycarbonate, a polyamide, a polyimide, a polyamideimide, a crosslinked polymer of cellulose and chitosan pyrrolidone carboxylate, and a derivative of chitin or chitosan are preferable, and among these binders, from the viewpoints of coating stability and adhesion improvement, the polyvinylidene fluoride, copolymer of vinylidene fluoride and hexafluoropropylene, polyimide, and polyamideimide are preferable, and the polyvinylidene fluoride and copolymer of vinylidene fluoride and hexafluoropropylene, which are resins containing fluorine, are more preferable. Further, examples of the derivative of chitosan include a polymer compound of chitosan glycerylated and a crosslinked product of chitosan.

The lower limit of the content of the binder in the positive active material layer is preferably 0.1% by mass, more preferably 0.5% by mass, still more preferably 1.0% by mass. The upper limit of the content of the binder is preferably 2.0% by mass, more preferably 1.8% by mass, still more preferably 1.5% by mass. The content of the binder is adjusted to be equal to or more than the lower limit mentioned above and equal to or less than the upper limit mentioned above, thereby allowing the effect of suppressing a decrease in the capacity retention ratio of the energy storage device after a charge-discharge cycle to be enhanced, and allowing the solubility of the binder in the solvent of the positive composite paste to be improved.

The conductive agent is not particularly limited as long as the agent is a material with conductivity. Examples of such a conductive agent include carbonaceous materials, metals, and conductive ceramics. Examples of the carbonaceous materials include graphite, non-graphitic carbon, and graphene-based carbon. Examples of the non-graphitic carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the form of the conductive agent include a powdery form and a fibrous form. As the conductive agent, one of these materials may be used alone, or two or more thereof may be used in mixture. In addition, these materials may be used in combination. For example, a composite material of carbon black and CNT may be used. Among these materials, carbon black is preferable from the viewpoints of electron conductivity and coatability, and in particular, acetylene black is preferable.

The content of the conductive agent in the positive active material layer is preferably 1% by mass or more and 10% by mass or less, more preferably 3% by mass or more and 9% by mass or less. The content of the conductive agent falls within the range mentioned above, thereby allowing the energy density of the energy storage device to be increased.

Examples of the thickener include polysaccharide polymers such as a carboxymethylcellulose (CMC) and a methylcellulose. When the thickener mentioned above has a functional group that is reactive with lithium and the like, the functional group may be deactivated by methylation or the like in advance.

The filler is not particularly limited. Examples of the filler include polyolefins such as polypropylene and polyethylene, inorganic oxides such as silicon dioxide, alumina, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, and barium sulfate, nitrides such as aluminum nitride and silicon nitride, and substances derived from mineral resources, such as talc, montmorillonite, boehmite, zeolite, apatite, kaolin, mullite, spinel, olivine, sericite, bentonite and mica, or artificial products thereof.

The positive active material layer may contain a typical nonmetal element such as B, N, P, F, Cl, Br, and I, a typical metal element such as Li, Na, Mg, Al, K, Ca, Zn, Ga, Ge, Sn, Sr, and Ba, or a transition metal element such as Sc, Ti, V, Cr, Mn, Fe, Co, Ni, Cu, Mo, Zr, Nb, and W as a component other than the positive active material, the conductive agent, the binder, the thickener, and the filler.

The positive electrode can be fabricated, for example, by applying a positive composite paste to a positive substrate directly or with an intermediate layer interposed therebetween, and drying the paste. The positive composite paste includes respective components constituting the positive active material layer, such as the positive active material particles, binder with a weight average molecular weight of 500,000 or more, and conductive agent and filler as optional components. The positive composite paste typically further includes a dispersion medium. As the dispersion medium, a nonaqueous solvent is suitably used as described above. Examples of the nonaqueous solvent that is a dispersion medium for use in preparing the positive composite paste include N-methylpyrrolidone (NMP) and toluene.

### Energy Storage Device

An energy storage device according to an embodiment of the present invention includes: an electrode assembly including a positive electrode, a negative electrode, and a separator; a nonaqueous electrolyte; and a case that houses the electrode assembly and the nonaqueous electrolyte. The electrode assembly is typically a stacked type obtained by stacking a plurality of positive electrodes and a plurality of negative electrodes with separators interposed therebetween, or a wound type obtained by winding a positive electrode and a negative electrode stacked with a separator interposed therebetween. The nonaqueous electrolyte is present with the positive electrode, negative electrode, and separator impregnated with the electrolyte. A nonaqueous electrolyte secondary battery (hereinafter, also referred to simply as a “secondary battery”) will be described as an example of the energy storage device.

### Positive Electrode

The positive electrode included in the energy storage device is as described above. The energy storage device is, because of including the positive electrode, capable of suppressing a decrease in the capacity retention ratio of the energy storage device after a charge-discharge cycle.

### Negative Electrode

The negative electrode has a negative substrate and a negative active material layer disposed directly on the negative substrate or over the negative substrate with an intermediate layer interposed therebetween. The configuration of the intermediate layer is not particularly limited, and can be selected from the configurations exemplified for the positive electrode, for example.

The negative substrate has conductivity. As the material of the negative substrate, a metal such as copper, nickel, stainless steel, nickel-plated steel, or aluminum, an alloy thereof, a carbonaceous material, or the like is used. Among these metals and alloys, the copper or copper alloy is preferable. Examples of the negative substrate include a foil, a deposited film, a mesh, and a porous material, and a foil is preferable from the viewpoint of cost. Accordingly, the negative substrate is preferably a copper foil or a copper alloy foil. Examples of the copper foil include a rolled copper foil and an electrolytic copper foil.

The average thickness of the negative substrate is preferably 2 μm or more and 35 μm or less, more preferably 3 μm or more and 30 μm or less, still more preferably 4 μm or more and 25 μm or less, and particularly preferably 5 μm or more and 20 μm or less. The average thickness of the negative substrate falls within the range mentioned above, thereby allowing the energy density per volume of the secondary battery to be increased while increasing the strength of the negative substrate.

The negative active material layer includes a negative active material. The negative active material layer includes optional components such as a conductive agent, a binder, a thickener, and a filler, if necessary.

The negative active material layer may contain a typical nonmetal element such as B, N, P, F, Cl, Br, and I, a typical metal element such as Li, Na, Mg, Al, K, Ca, Zn, Ga, Ge, Sn, Sr, and Ba, or a transition metal element such as Sc, Ti, V, Cr, Mn, Fe, Co, Ni, Cu, Mo, Zr, Ta, Hf, Nb, and W as a component other than the negative active material, the conductive agent, the binder, the thickener, and the filler.

The negative active material can be appropriately selected from known negative active materials. As the negative active material for a lithium ion secondary battery, a material capable of occluding and releasing lithium ions is typically used. Examples of the negative active material include metal Li; metals or metalloids such as Si and Sn; metal oxides or metalloid oxides such as oxides of Si, oxides of Ti, and oxides of Sn; titanium-containing oxides such as Li₄Ti₅O₁₂, LiTiO₂, and TiNb₂O₇; polyphosphoric acid compounds; silicon carbides; and carbon materials such as graphite and non-graphitic carbon (easily graphitizable carbon or hardly graphitizable carbon). Among these materials, the graphite and the non-graphitic carbon are preferable. In the negative active material layer, one of these materials may be used alone, or two or more thereof may be used in mixture.

The term “graphite” refers to a carbon material in which the average lattice spacing (d₀₀₂) of the (002) plane determined by an X-ray diffraction method before charge-discharge or in a discharged state is 0.33 nm or more and less than 0.34 nm. Examples of the graphite include natural graphite and artificial graphite. Artificial graphite is preferable from the viewpoint that a material that has stable physical properties can be obtained.

The term “non-graphitic carbon” refers to a carbon material in which the average grid spacing (d₀₀₂) of the (002) plane determined by an X-ray diffraction method before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from a petroleum pitch, a petroleum coke or a material derived from a petroleum coke, a plant-derived material, and an alcohol-derived material.

In this regard, the “discharged state” means a state discharged such that lithium ions that can be occluded and released in association with charge-discharge are sufficiently released from the carbon material as the negative active material. For example, the “discharged state” refers to a state where the open circuit voltage is 0.7 V or higher in a half cell that has, for use as a working electrode, a negative electrode containing a carbon material as a negative active material, and has metal Li for use as a counter electrode.

The “hardly graphitizable carbon” refers to a carbon material in which the door is 0.36 nm or more and 0.42 nm or less.

The “easily graphitizable carbon” refers to a carbon material in which the door is 0.34 nm or more and less than 0.36 nm.

The negative active material is typically particles (powder). The average particle size of the negative active material can be, for example, 1 nm or more and 100 μm or less. When the negative active material is a carbon material, a titanium-containing oxide, or a polyphosphoric acid compound, the average particle size thereof may be 1 μm or more and 100 μm or less. When the negative active material is Si, Sn, an oxide of Si, an oxide of Sn, or the like, the average particle size thereof may be 1 nm or more and 1 μm or less. By setting the average particle size of the negative active material to be equal to or more than the lower limit mentioned above, the negative active material is easily produced or handled. By setting the average particle size of the negative active material to be equal to or less than the upper limit mentioned above, the electron conductivity of the active material layer is improved. A crusher, a classifier, or the like is used in order to obtain a powder with a predetermined particle size. The crushing method and classification method can be selected from, for example, the methods exemplified for the positive electrode. When the negative active material is a metal such as metal Li, the negative active material may have the form of a foil.

The content of the negative active material in the negative active material layer is preferably 60% by mass or more and 99% by mass or less, more preferably 90% by mass or more and 98% by mass or less. The content of the negative active material falls within the range mentioned above, thereby allowing a balance to be achieved between the increased energy density and productivity of the negative active material layer. The optional components such as a conductive agent, a thickener and a filler can be selected from the materials exemplified for the positive electrode.

Examples of the binder mentioned above include: thermoplastic resins such as fluororesins (e.g., polytetrafluoroethylene (PTFE), polyvinylidene fluoride (PVDF)), polyethylene, polypropylene, polyacryl, and polyimide; elastomers such as an ethylene-propylene-diene rubber (EPDM), sulfonated EPDM, a styrene butadiene rubber (SBR), and a fluororubber; and polysaccharide polymers.

The content of the binder in the negative active material layer is preferably 1% by mass or more and 10% by mass or less, more preferably 3% by mass or more and 9% by mass or less. The content of the binder falls within the range mentioned above, thereby allowing the negative active material to be stably held.

### Separator

The separator can be appropriately selected from known separators. As the separator, for example, a separator composed of only a substrate layer, a separator where a heat resistant layer containing heat resistant particles and a binder is formed on one surface or both surfaces of the substrate layer, or the like can be used. Examples of the form of the substrate layer of the separator include a woven fabric, a nonwoven fabric, and a porous resin film. Among these forms, the porous resin film is preferable from the viewpoint of strength, and the nonwoven fabric is preferable from the viewpoint of liquid retaining property of the nonaqueous electrolyte. As the material for the substrate layer of the separator, for example, a polyolefin such as polyethylene or polypropylene is preferable from the viewpoint of shutdown function, and polyimide, aramid, or the like is preferable from the viewpoint of resistance to oxidative decomposition. As the substrate layer of the separator, a material obtained by combining these resins may be used.

The heat resistant particles included in the heat resistant layer preferably have a mass loss of 5% or less in the case of temperature increase from room temperature to 500° C. under the air atmosphere of 1 atm, and more preferably have a mass loss of 5% or less in the case of temperature increase from room temperature to 800° C. Examples of materials that have a mass loss equal to or less than a predetermined value include inorganic compounds. Examples of the inorganic compound include oxides such as iron oxide, silicon oxide, aluminum oxide, titanium dioxide, zirconium oxide, calcium oxide, strontium oxide, barium oxide, magnesium oxide and aluminosilicate; nitrides such as aluminum nitride and silicon nitride; carbonates such as calcium carbonate; sulfates such as barium sulfate; hardly soluble ionic crystals such as calcium fluoride, barium fluoride, barium titanate; covalently bonded crystals such as silicon and diamond; and substances derived from mineral resources, such as talc, montmorillonite, boehmite, zeolite, apatite, kaolin, mullite, spinel, olivine, sericite, bentonite, and mica, and artificial products thereof. As the inorganic compounds, simple substances or complexes of these substances may be used alone, or two or more thereof may be used in mixture. Among these inorganic compounds, the silicon oxide, aluminum oxide, or aluminosilicate is preferable from the viewpoint of the safety of the energy storage device.

The porosity of the separator is preferably 80% by volume or less from the viewpoint of strength, and is preferably 20% by volume or more from the viewpoint of discharge performance. The “porosity” herein is a volume-based value, which means a value measured with a mercury porosimeter.

As the separator, a polymer gel composed of a polymer and a nonaqueous electrolyte may be used. Examples of the polymer include a polyacrylonitrile, a polyethylene oxide, a polypropylene oxide, a polymethyl methacrylate, a polyvinyl acetate, a polyvinylpyrrolidone, and a polyvinylidene fluoride. The use of the polymer gel has the effect of suppressing liquid leakage. As the separator, the polymer gel may be used in combination with a porous resin film, a nonwoven fabric, or the like as described above.

### Nonaqueous Electrolyte

The nonaqueous electrolyte can be appropriately selected from known nonaqueous electrolytes. For the nonaqueous electrolyte, a nonaqueous electrolyte solution may be used. The nonaqueous electrolyte solution includes a nonaqueous solvent and an electrolyte salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, solvents in which some of the hydrogen atoms included in these compounds are substituted with halogen may be used.

Examples of the cyclic carbonates include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among these carbonates, EC is preferable.

Examples of the chain carbonates include diethyl carbonate (DEC), dimethyl carbonate (DMC), ethyl methyl carbonate (EMC), diphenyl carbonate, trifluoroethyl methyl carbonate, and bis(trifluoroethyl)carbonate. Among these carbonates, EMC is preferable.

As the nonaqueous solvent, it is preferable to use the cyclic carbonate or the chain carbonate, and it is more preferable to use the cyclic carbonate and the chain carbonate in combination. The use of the cyclic carbonate allows the promoted dissociation of the electrolyte salt to improve the ionic conductivity of the nonaqueous electrolyte solution. The use of the chain carbonate allows the viscosity of the nonaqueous electrolyte solution to be kept low. When the cyclic carbonate and the chain carbonate are used in combination, the volume ratio of the cyclic carbonate to the chain carbonate (cyclic carbonate:chain carbonate) preferably falls within the range from 5:95 to 50:50, for example.

The electrolyte salt can be appropriately selected from known electrolyte salts. Examples of the electrolyte salt include a lithium salt, a sodium salt, a potassium salt, a magnesium salt, and an onium salt. Among these salts, the lithium salt is preferable.

Examples of the lithium salt include inorganic lithium salts such as LiPF₆, LiPO₂F₂, LiBF₄, LiClO₄, and LiN(SO₂F)₂, lithium oxalates such as lithium bis(oxalate)borate (LiBOB), lithium difluorooxalatoborate (LiFOB), and lithium bis(oxalate)difluorophosphate (LiFOP), and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃, and LiC(SO₂C₂F₅)₃. Among these salts, the inorganic lithium salts are preferable, and LiPF₆ is more preferable.

The content of the electrolyte salt in the nonaqueous electrolyte solution is, at 20° C. under 1 atm, preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, particularly preferably 0.7 mol/dm³ or more and 1.5 mol/dm³ or less. The content of the electrolyte salt falls within the range mentioned above, thereby allowing the ionic conductivity of the nonaqueous electrolyte solution to be increased.

The nonaqueous electrolyte solution may include an additive, besides the nonaqueous solvent and the electrolyte salt. Examples of the additive include oxalic acid salts such as lithium bis(oxalate)borate (LiBOB), lithium difluorooxalatoborate (LiFOB), and lithium bis(oxalate)difluorophosphate (LiFOP); imide salts such as lithium bis(fluorosulfonyl)imide (LiFSI); aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds, such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, cyclohexanedicarboxylic anhydride; ethylene sulfite, propylene sulfite, dimethyl sulfite, methyl methanesulfonate, busulfan, methyl toluenesulfonate, dimethyl sulfate, ethylene sulfate, sulfolane, dimethyl sulfone, diethyl sulfone, dimethylsulfoxide, diethylsulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, 1,3-propene sultone, 1,3-propane sultone, 1,4-butane sultone, 1,4-butene sultone, perfluorooctane, tristrimethylsilyl borate, tristrimethylsilyl phosphate, tetrakistrimethylsilyl titanate, lithium monofluorophosphate, and lithium difluorophosphate. One of these additives may be used alone, or two or more thereof may be used in mixture.

The content of the additive contained in the nonaqueous electrolyte solution is preferably 0.01% by mass or more and 10% by mass or less, more preferably 0.1% by mass or more and 7% by mass or less, still more preferably 0.2% by mass or more and 5% by mass or less, particularly preferably 0.3% by mass or more and 3% by mass or less, with respect to a total mass of the nonaqueous electrolyte solution. The content of the additive falls within the range mentioned, thereby making it possible to improve capacity retention performance or cycle performance after high-temperature storage, and to further improve safety.

For the nonaqueous electrolyte, a solid electrolyte may be used, or a nonaqueous electrolyte solution and a solid electrolyte may be used in combination. The solid electrolyte can be selected from arbitrary materials with ionic conductivity, which are solid at normal temperature (for example, 15° C. to 25° C.), such as lithium, sodium, and calcium. Examples of the solid electrolyte include a sulfide solid electrolyte, an oxide solid electrolyte, an oxynitride solid electrolyte, polymer solid electrolyte, and a gel polymer electrolyte.

Examples of the sulfide solid electrolyte include Li₂S—P₂S₅, LiI—Li₂S—P₂S₅, and Li₁₀Ge—P₂S₁₂ in the case of a lithium ion secondary battery. The shape of the energy storage device according to the present embodiment is not to be considered particularly limited, and examples thereof include cylindrical batteries, prismatic batteries, flattened batteries, coin batteries and button batteries.

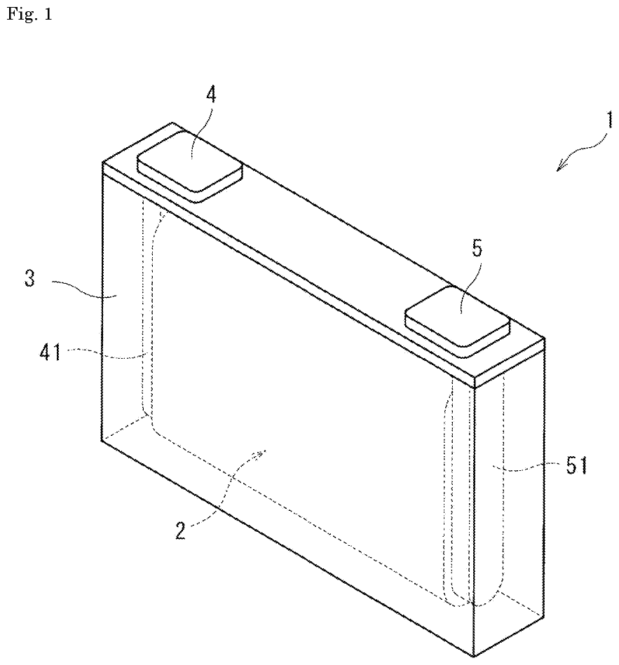

FIG. 1 illustrates an energy storage device 1 as an example of a prismatic battery. It is to be noted that FIG. 1 is a view illustrating the inside of a case in a perspective manner. An electrode assembly 2 including a positive electrode and a negative electrode wound with a separator interposed therebetween is housed in a prismatic case 3. The positive electrode is electrically connected to a positive electrode terminal 4 via a positive electrode lead 41. The negative electrode is electrically connected to a negative electrode terminal 5 via a negative electrode lead 51.

### Configuration of Energy Storage Apparatus

The energy storage device according to the present embodiment can be mounted as an energy storage unit (battery module) configured with a plurality of energy storage devices assembled, on power sources for automobiles such as electric vehicles (EV), hybrid vehicles (HEV), and plug-in hybrid vehicles (PHEV), power sources for electronic devices such as personal computers and communication terminals, power sources for power storage, or the like. In this case, the technique of the present invention may be applied to at least one energy storage device included in the energy storage unit. An energy storage apparatus according to an embodiment of the present invention includes two or more energy storage devices, and includes one or more energy storage devices according to an embodiment of the present invention (hereinafter, referred to as “second embodiment”). The technique according to an embodiment of the present invention may be applied to at least one energy storage device included in the energy storage apparatus according to the second embodiment, and the energy storage apparatus may include one energy storage device according to an embodiment of the present invention and include one or more energy storage devices not according to an embodiment of the present invention, or may include two or more energy storage devices according to an embodiment of the present invention.

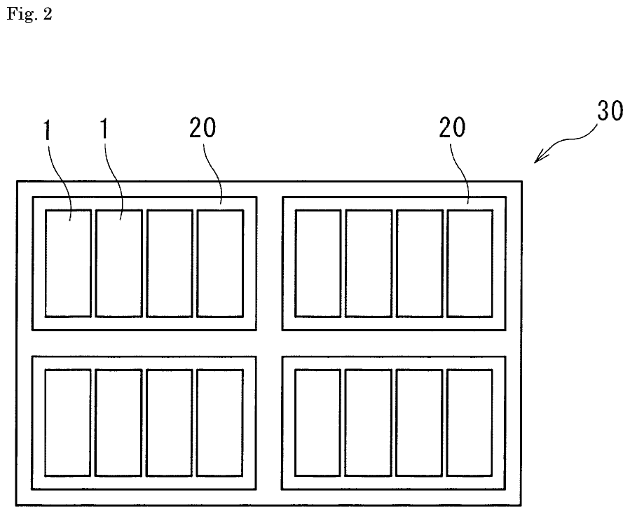

FIG. 2 illustrates an example of an energy storage apparatus 30 according to the second embodiment, obtained by further assembling energy storage units 20 that each have two or more electrically connected energy storage devices 1 assembled. The energy storage apparatus 30 may include a busbar (not shown) that electrically connects two or more energy storage devices 1, a busbar (not shown) that electrically connects two or more energy storage units 20, and the like. The energy storage unit 20 or the energy storage apparatus 30 may include a state monitor (not shown) that monitors the state of one or more energy storage devices 1.

### Method for Manufacturing Energy Storage Device

A method for manufacturing the energy storage device according to the present embodiment can be appropriately selected from known methods. The manufacturing method includes, for example, preparing an electrode assembly, preparing a nonaqueous electrolyte, and housing the electrode assembly and the nonaqueous electrolyte in a case. The preparation of the electrode assembly includes: preparing the positive electrode described above and a negative electrode, and forming an electrode assembly by stacking or winding the positive electrode and the negative electrode with a separator interposed therebetween.

Housing the nonaqueous electrolyte in the case can be appropriately selected from known methods. For example, in the case of using a nonaqueous electrolyte solution for the nonaqueous electrolyte, the nonaqueous electrolyte solution may be injected from an inlet formed in the case, followed by sealing the inlet.

The energy storage device includes the positive electrode, thereby allowing the suppression of a decrease in the capacity retention ratio of the energy storage device after a charge-discharge cycle.

### Other Embodiments

It is to be noted that the energy storage device according to the present invention is not to be considered limited to the embodiment mentioned above, and various changes may be made without departing from the scope of the present invention. For example, to the configuration according to one embodiment, the configuration according to another embodiment can be added, and a part of the configuration according to one embodiment can be replaced with the configuration according to another embodiment or a well-known technique. Furthermore, a part of the configuration according to one embodiment can be deleted. In addition, a well-known technique can be added to the configuration according to one embodiment.

While the case where the energy storage device is used as a nonaqueous electrolyte secondary battery (for example, lithium ion secondary battery) that can be charged and discharged has been described in the embodiment mentioned above, the type, shape, dimensions, capacity, and the like of the energy storage device are arbitrary. The present invention can also be applied to various secondary batteries, and capacitors such as electric double layer capacitors and lithium ion capacitors.

While the electrode assembly with the positive electrode and the negative electrode stacked with the separator interposed therebetween has been described in the embodiment mentioned above, the electrode assembly may include no separator. For example, the positive electrode and the negative electrode may be brought into direct contact with each other, with a non-conductive layer formed on the active material layer of the positive electrode or negative electrode.

### EXAMPLES

Hereinafter, the present invention will be described more specifically with reference to examples. The present invention is not limited to the following examples.

### Example 1

### Fabrication of Positive Electrode

LiNi_{0.6}Co_{0.2}Mn_{0.2}O₂ (NCM 622) particles with an α-NaFeO₂-type crystal structure, composed of primary particles (single-particle-based particles) that were not substantially aggregated, with the product of the median size and the BET specific surface area being 3.0 [μm m²/g], were used as positive active material particles. A polyvinylidene fluoride with a weight average molecular weight of 880,000 was used as a binder, and carbon black was used as a conductive agent. Prepared was a positive composite paste including 1.5% by mass of the binder in terms of solid content, 4.0% by mass of the conductive agent, and 94.5% by mass of the positive active material particles, and including N-methyl-pyrrolidone (NMP) as a dispersion medium. This positive composite paste was applied onto a surface of an aluminum foil as a positive substrate, and dried to prepare a positive active material layer. Thereafter, roll pressing was performed to obtain a positive electrode according to Example 1.

### Fabrication of Negative Electrode

Prepared was a negative composite paste including graphite as a negative active material, a styrene butadiene rubber (SBR), and a carboxymethyl cellulose (CMC) at ratios by mass of 97:2:1 (in terms of solid content) with water as a dispersion medium. The negative composite paste was applied onto a surface of a copper foil as a negative substrate, and dried to prepare a negative active material layer. Thereafter, roll pressing was performed to obtain a negative electrode.

### Fabrication of Energy Storage Device

An energy storage device with the positive electrode and the negative electrode used was assembled. Further, a solution obtained by dissolving a lithium hexafluorophosphate (LiPF₆) as an electrolyte salt at a concentration of 1.0 mol/dm³ in a nonaqueous solvent obtained by mixing an ethylene carbonate (EC), an ethylmethyl carbonate (EMC), and a dimethyl carbonate (DMC) at ratios by volume of 30:40:40 was used as a nonaqueous electrolyte, and a polyolefin microporous membrane was used as a separator.

### Comparative Example

A positive electrode and an energy storage device according to Comparative Example 1 were fabricated similarly to Example 1, except for using, as positive active material particles, particles of NCM 622 composed of secondary particles with the ratio of the median size to the average primary particle size being more than 5, with the product of the median size and the BET specific surface area being 4.5 [μm m²/g], using, as a binder, a polyvinylidene fluoride with the weight average molecular weight shown in Table 1, and adjusting the proportions of the positive active material, conductive agent, and binder to be 93:4:3 (in terms of solid content).

### Comparative Example 2

A positive electrode and an energy storage device according to Comparative Example 2 were fabricated similarly to Example 1, except for using, as positive active material particles, particles of NCM 622 composed of secondary particles with the ratio of the median size to the average primary particle size being more than 5, with the product of the median size and the BET specific surface area being 4.5 [μm m²/g].

### Comparative Example 3

A positive electrode and an energy storage device according to Comparative Example 3 were fabricated similarly to Example 1, except for using, as a binder, a polyvinylidene fluoride with the weight average molecular weight shown in Table 1, and adjusting the proportions of the positive active material, conductive agent, and binder to be 93:4:3 (in terms of solid content).

### Reference Example 1

A positive electrode according to Reference Example 1 was fabricated similarly to Example 1, except for using, as positive active material particles, particles of NCM 622 composed of secondary particles with the ratio of the median size to the average primary particle size being more than 5, with the product of the median size and the BET specific surface area being 4.5 [μm m²/g], and using, as a binder, a polyvinylidene fluoride with the weight average molecular weight shown in Table 1.

### Reference Example 2

A positive electrode according to Reference Example 2 was fabricated similarly to Example 1, except for using, as a binder, a polyvinylidene fluoride with the weight average molecular weight shown in Table 1.

### Evaluation

### Measurement of Initial Discharge Capacity

Each of the energy storage devices obtained was subjected to constant current charge up to 4.20 V at a charge current of 0.2 C under a temperature environment of 25° C., and then to constant voltage charge at 4.20V. With regard to the charge termination conditions, the charge was performed until the total charge time reached 7 hours. After a pause time of 10 minutes was provided, the energy storage device was subjected to constant current discharge to 2.75 V at a discharge current of 0.2 C, and a pause time of 10 minutes was provided. Subsequently, the energy storage device was subjected to constant current charge up to 4.20V at a charge current of 1.0 C, and then to constant voltage charge at 4.20 V. With regard to the charge termination conditions, the charge was performed until the total charge time reached 3 hours. After a pause time of 10 minutes was provided, the energy storage device was subjected to constant current discharge to 2.75 V at a discharge current of 1.0 C. The discharge capacity at the discharge current of 1.0 C was defined as an “initial discharge capacity”.

### Charge-Discharge Cycle Test

The energy storage devices according to Example 1, Comparative Example 1 to Comparative Example 3, and Reference Example 1 and Reference Example 2, subjected to the measurement of the initial discharge capacity, were subjected to a charge-discharge cycle test under the following conditions. First, the energy storage devices were stored in a thermostatic chamber at 45° C. for 5 hours, and then each subjected to constant current charge at a charge current of 1.0 C up to a voltage corresponding to the SOC (State of Charge) of 100%. Next, after the charge, a pause of 10 minutes was provided. Thereafter, the energy storage devices were constant current discharge at a discharge current of 1.0 C to a voltage corresponding to the SOC of 0%, and then, a pause time of 10 minutes was provided. The charge, discharge, and pause steps were defined as one cycle, and five hundred cycles of charge discharge were repeated in the thermostatic chamber at 45° C.

### Capacity Retention Ratio After Charge-Discharge Cycle Test

The energy storage devices according to Example 1, Comparative Example 1 to Comparative Example 3, Reference Example 1 and Reference Example 2 were subjected to constant current charge at a charge current of 1.0 C up to 4.20 V under a temperature environment of 25° C., and then subjected to constant voltage charge at 4.20 V. With regard to the charge termination conditions, the charge was performed until the total charge time reached 3 hours. After a pause time of 10 minutes was provided, the energy storage device was subjected to constant current discharge to 2.75 V at a discharge current of 1.0 C. The discharge capacity at this time was defined as a “discharge capacity after the charge-discharge cycle”. The percentage of the discharge capacity after the charge-discharge cycle test with respect to the initial discharge capacity was defined as a “capacity retention ratio after the charge-discharge cycle test (%)”. The discharge capacity retention ratios after the charge-discharge cycle test are shown in Table 1.

TABLE 1

| | | | | | | | | | Evaluation |
|---|---|---|---|---|---|---|---|---|---|
| | Positive active material | | | | | | | | Capacity |
| | | | | | Product of | | | | retention ratio |
| | | | | | median size and | Binder | | | after charge- |
| | | | Median | BET specific | BET specific | | | Content | discharge |
| | | Particle | size | surface area | surface area | | Molecular | [% by | cycle test |
| | Material | Form | [μm] | [μm · m²/g] | [μm · m²/g] | Material | weight | mass] | [%] |
| Comparative | NCM | Secondary | 9.0 | 0.5 | 4.5 | Polyvinylidene | 280000 | 3.0 | 88 |
| Example 1 | 622 | particle | | | | fluoride | | | |
| Comparative | NCM | Secondary | 9.0 | 0.5 | 4.5 | Polyvinylidene | 880000 | 1.5 | 87 |
| Example 2 | 622 | particle | | | | fluoride | | | |
| Comparative | NCM | Single | 5.0 | 0.6 | 3.0 | Polyvinylidene | 280000 | 3.0 | 88 |
| Example 3 | 622 | particle | | | | fluoride | | | |
| Example 1 | NCM | Single | 5.0 | 0.6 | 3.0 | Polyvinylidene | 880000 | 1.5 | 91 |
| | 622 | particle | | | | fluoride | | | |
| Reference | NCM | Secondary | 9.0 | 0.5 | 4.5 | Polyvinylidene | 280000 | 1.5 | Unevaluable |
| Example 1 | 622 | particle | | | | fluoride | | | |
| Reference | NCM | Single | 5.0 | 0.6 | 3.0 | Polyvinylidene | 280000 | 1.5 | Unevaluable |
| Example 2 | 622 | particle | | | | fluoride | | | |

From a comparison between Example 1 and Comparative Example 1 to Comparative Example 3, the use of the binder with the weight average molecular weight of 500,000 or more in combination with the positive active material particles that are single-particle-based particles with the product of the median size and the BET specific surface area being 1.3 [μm m²/g] or more and 4.0 [μm m²/g] or less is found to suppress a decrease in capacity retention ratio after the charge-discharge cycle test. In addition, from a comparison between Comparative Example 1 and Comparative Example 2, in the case of the positive active material particles that are secondary particles with the product of the median size and the BET specific surface area being more than 4.0 [μm m²/g], a decrease in capacity retention ratio after the charge-discharge cycle test is found not to be suppressed even when the weight average molecular weight of the binder is 500,000 or more. Accordingly, it has been demonstrated that the effect of suppressing a decrease in capacity retention ratio after the charge-discharge cycle is a remarkable effect that is produced when the positive active material particles that are single-particle-based particles with the product of the median size and the BET specific surface area being 1.3 [μm m²/g] or more and 4.0 [μm m²/g] or less are combined with the binder that has weight average molecular weight of 500,000 or more.

In contrast, in Reference Example 1 and Reference Example 2, regardless of whether or not the product of the median size and the BET specific surface area of the positive active material particles was 1.3 [μm m²/g] or more and 4.0 [μm m²/g] or less, the positive active material layer was peeled off from the positive substrate at the time of fabricating the positive electrode, thus, any energy storage device failed to be fabricated, and the capacity retention ratio after the charge-discharge cycle failed to be evaluated.

The foregoing results have shown that the positive electrode is capable of suppressing a decrease in the capacity retention ratio of the energy storage device after a charge-discharge cycle.

### DESCRIPTION OF REFERENCE SIGNS

1: Energy storage device
2: Electrode assembly
3: Case
4: Positive electrode terminal
41: Positive electrode lead
5: Negative electrode terminal
51: Negative electrode lead
20: Energy storage unit
30: Energy storage apparatus

1. A positive electrode for an energy storage device, comprising a positive active material layer,
wherein the positive active material layer contains positive active material particles and a binder,
the positive active material particles contain a nickel-containing lithium transition metal composite oxide that has an α-NaFeO₂-type crystal structure,
the positive active material particles are at least one of: primary particles that are not substantially aggregated; and secondary particles that have primary particles aggregated, with a ratio of a median size to an average primary particle size being 5 or less,
a product of the median size and a BET specific surface area of the positive active material particles is 1.3 [μm·m²/g] or more and 4.0 [μm·m²/g] or less, and
the binder has a weight average molecular weight of 500,000 or more.

2. The positive electrode according to claim 1, wherein the lithium transition metal composite oxide includes nickel, cobalt, and at least one of manganese and aluminum.

3. The positive electrode according to claim 1, wherein the binder contains a fluorine-containing resin.

4. The positive electrode according to claim 1, wherein a content of the binder in the positive active material layer is 0.1% by mass or more and 2.0% by mass or less.

5. An energy storage device comprising the positive electrode according to claim 1.

6. An energy storage apparatus comprising two or more energy storage devices, and comprising one or more energy storage devices according to claim 5.
